(19) United States
(12) Patent Application Publication
(10) Pub. No.: US 2004/0237605 A1
(43) Pub. Date: Dec. 2, 2004

(54) Luggage hasp

(75) Inventors: Jer Hong Lin, Taipei (TW); Boon Hwa Lau, Taipei (TW)

Correspondence Address: JER HONG LIN, Wu Ku Industrial Park, No. 29, Wu Chuang 3rd Rd., Wu Ku Hsiang, Taipei County, 248, CN

(73) Assignee: CHAW KHONG TECHNOLOGY CO., LTD., Wu Ku Hsiang (TW)

(21) Appl. No.: 10/826,395

(22) Filed: Apr. 19, 2004

(30) Foreign Application Priority Data
May 29, 2003 (CN) 03263985.6

(51) Int. Cl. E05B 67/38

(52) U.S. Cl. 70/68

(57) ABSTRACT

A luggage hasp is provided on luggage having two zippers. In a closed state, tabs of the zippers are put on protuberances, a trigger member is seated across a channel with an outer end thereof projected from the channel, a spring depressible bar disposed in the channel, a cavity ridden on a second rail, and an inner end thereof disposed in a well, a sliding board is disposed on a base with side lugs being aligned so that a padlock is operative to fasten the lugs. Unlocking the lugs and sliding the sliding board away from the base will slide a first rail along a groove, slide a second rail along a cavity, and compress a spring until a dent has reached a position below the cavity to push the trigger member outwardly to move an inner end thereof in the dent with the protuberances being exposed.

### BACKGROUND OF THE INVENTION

1. Field of The Invention

The present invention relates to luggage hasps and more particularly to an improved hasp operated in cooperation with two zippers so that the hasp can be fastened by a padlock when the zippers are pulled to close the luggage and two tabs of the zippers are put on two protuberances in the hasp.

2. Description of Related Art

For most luggage cases, locks are provided so that articles stored therein can be well protected. Conventionally, main body of a luggage case may be of a hard-side (e.g., molded thermoplastic) or soft-side (e.g., fabric) construction in which the latter is pertinent to the present invention as described in the following sections. There have been numerous suggestions in prior patents related to luggage locks each being operated in cooperation with a hasp. For example, U.S. Pat. No. 3,978,697 discloses a zipper lock mounted on a luggage case in which the tabs of two zippers are pulled to dispose in a space covered by a base and a sliding board in a hasp prior to locking. However, the prior patent suffered from a couple of disadvantages. For example, the space should be sufficient, resulting in a bulky design. Further, the hasp may not be able to cooperate with the tabs of new zippers if they have a size different from the original ones when the original zippers are replaced by new ones due to malfunction. Thus, the need for improvement still exists.

### SUMMARY OF THE INVENTION

It is an object of the present invention to provide a simple, easily operable, and trouble free luggage hasp associated with two zippers.

To achieve the above and other objects, the present invention provides a hasp mounted on a piece of luggage having two zippers which are operative to open or close the piece of luggage, comprising a base including a four-sided flat having two spaced protuberances formed thereon, first, second, and third raised portions at three sides of the flat, a lengthwise groove on the first raised portion, a transverse channel having a reduced opening under the groove, and a hole-shaped first positioning member projected from the first raised portion; a sliding board including a four-sided top, an elongate bottom plate under the top by a predetermined distance, a hole-shaped second positioning member projected from one side, a lengthwise first rail on a bottom of the top, a second rail along one side of the bottom plate, the second rail parallel to the first rail, and a dent on the second rail; a spring seat secured to the base and including a lengthwise receptacle on a bottom, a projecting rod at one end of the receptacle, and a well adjacent one end; a spring assembly including a spring having one end fixed at the rod, and a moveable support fixed at the other end of the spring and secured to the sliding board; and a trigger member including a flange adjacent an outer end, a spring depressible bar, and a cavity on a bottom of the bar proximate an inner end, wherein in a closed state of each of the hasp and the piece of luggage, one ends of tabs of the zippers are put on the protuberances, the trigger member is seated across the channel with an outer end thereof projected from the channel, the bar disposed in the channel, the flange spaced apart from a shoulder of the channel, the cavity ridden on the second rail, and an inner end thereof disposed in the well, the sliding board is disposed on the first and the second raised portions and above the flat with the first positioning member aligned with the second positioning member so that a padlock is operative to fasten the first and the second positioning members, whereby unlocking the first and the second positioning members and sliding the sliding board away from the third raised portion will slide the first rail along the groove, slide the second rail along the cavity, and compress the spring until the dent has reached a position below the cavity to push the trigger member outwardly to urge the flange against the shoulder of the channel and move the inner end of the trigger member in the dent with the protuberances being exposed due to an expansion of the spring depressible bar.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of hasp according to the invention, the hasp and a cooperating padlock being mounted on a luggage case;

FIG. 2 is an enlarged view of the hasp in FIG. 1;

FIG. 3 is an exploded perspective view of the hasp in FIG. 2;

FIG. 4 is a perspective view of the hasp in a nonoperating position;

FIG. 5 is a perspective view of the hasp in an open position with two tabs being separate;

FIG. 6 is another exploded perspective view of the hasp in FIG. 2;

FIG. 7 is a sectional view of the hasp shown in FIG. 4;

FIG. 8 is a sectional view of the hasp shown in FIG. 5;

FIG. 9 is a sectional view taken along line 9-9 of FIG. 7; and

FIG. 10 is a sectional view taken along line 10-10 of FIG. 8.

### DETAILED DESCRIPTION OF THE PREFERRED EMBODIMENTS

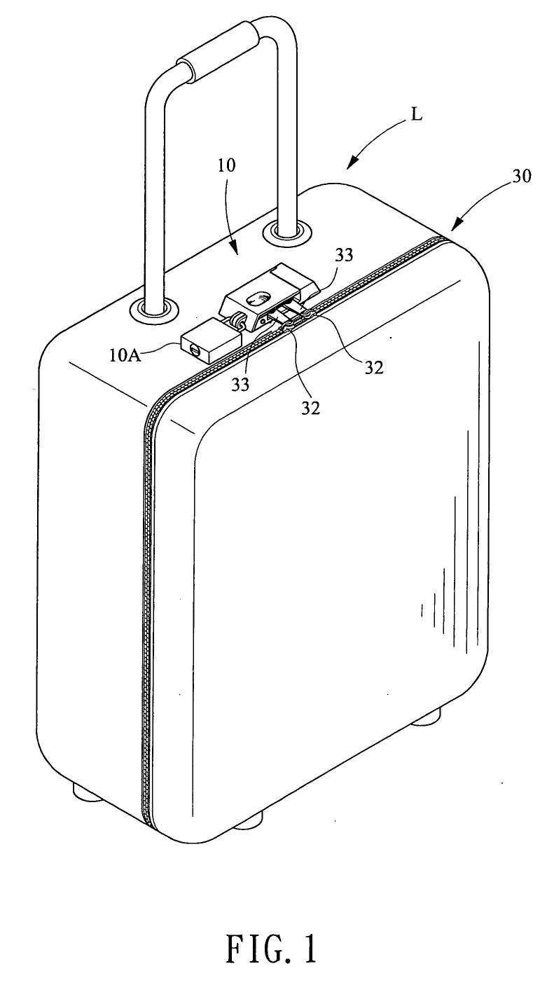

Referring to FIG. 1, there is shown a preferred embodiment of hasp 10 according to the invention in which the hasp 10 and a cooperating padlock 10A for fastening the hasp 10 are mounted on a luggage case L. As shown, the luggage case L is closed by two zippers 30 by pulling tabs 33 toward each other to a minimum distance and one ends of the tabs 33 coupled to the zippers 32 are located in the hasp 10. Each component of the hasp 10 and other associated elements will be described in detail below.

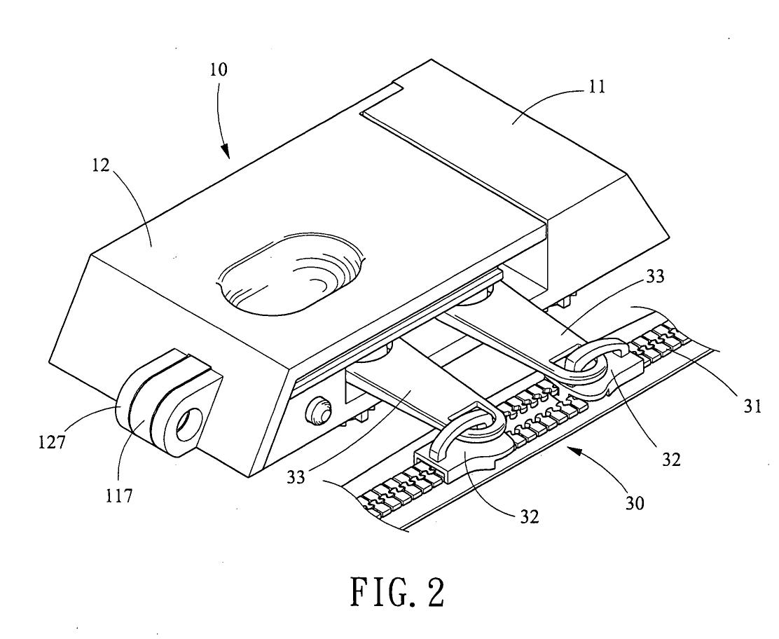

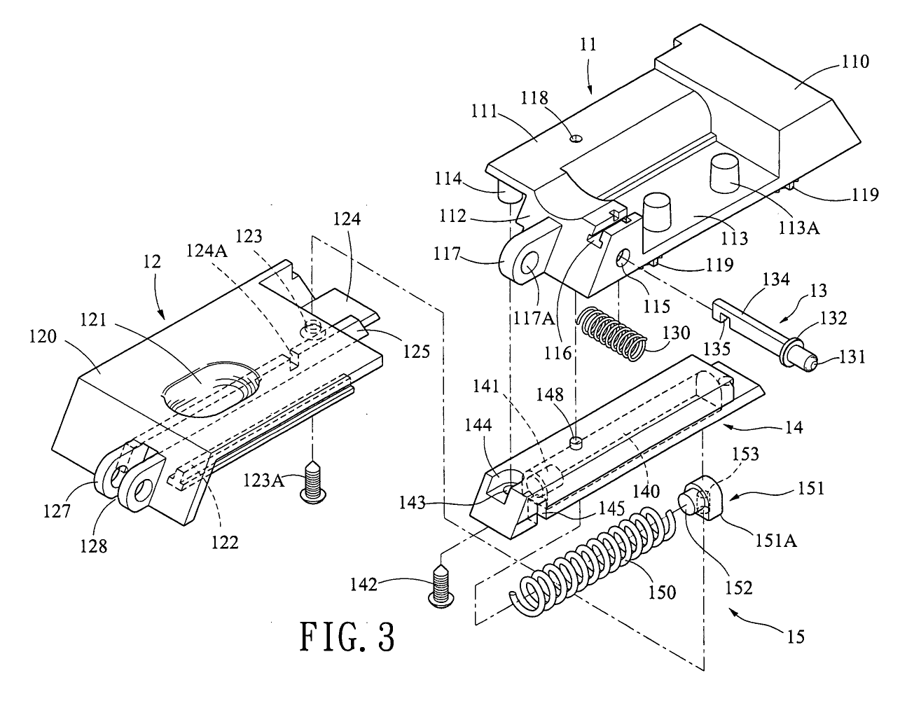

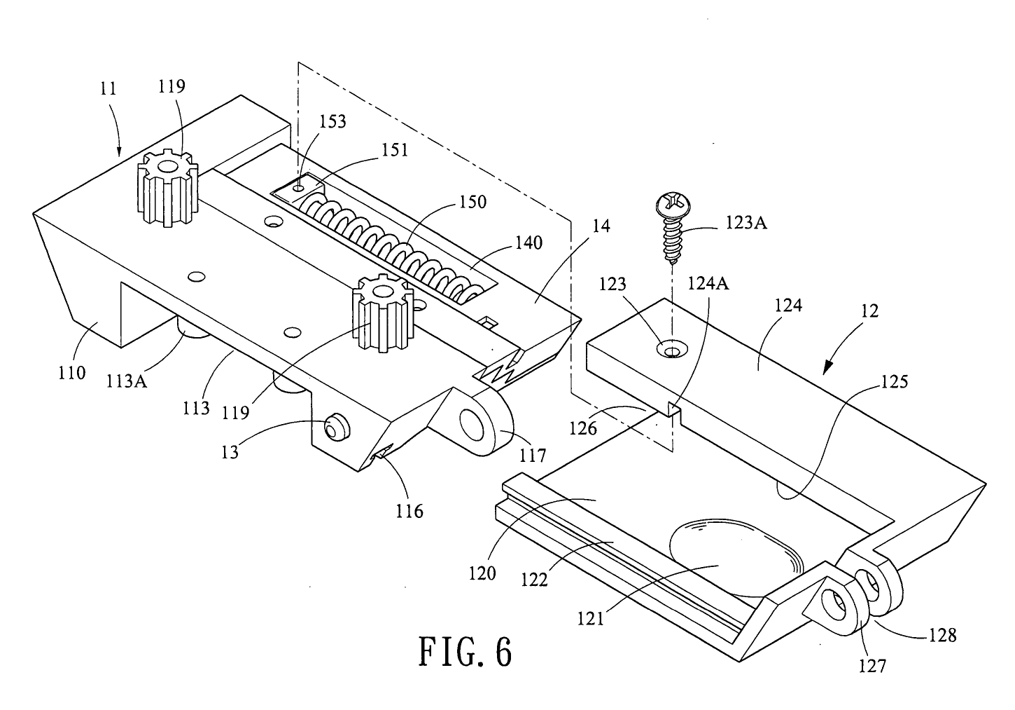

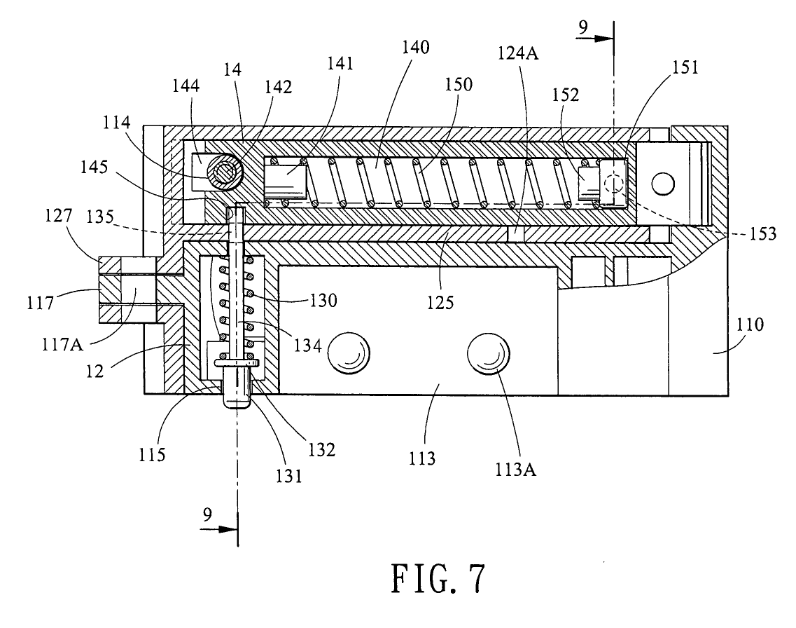

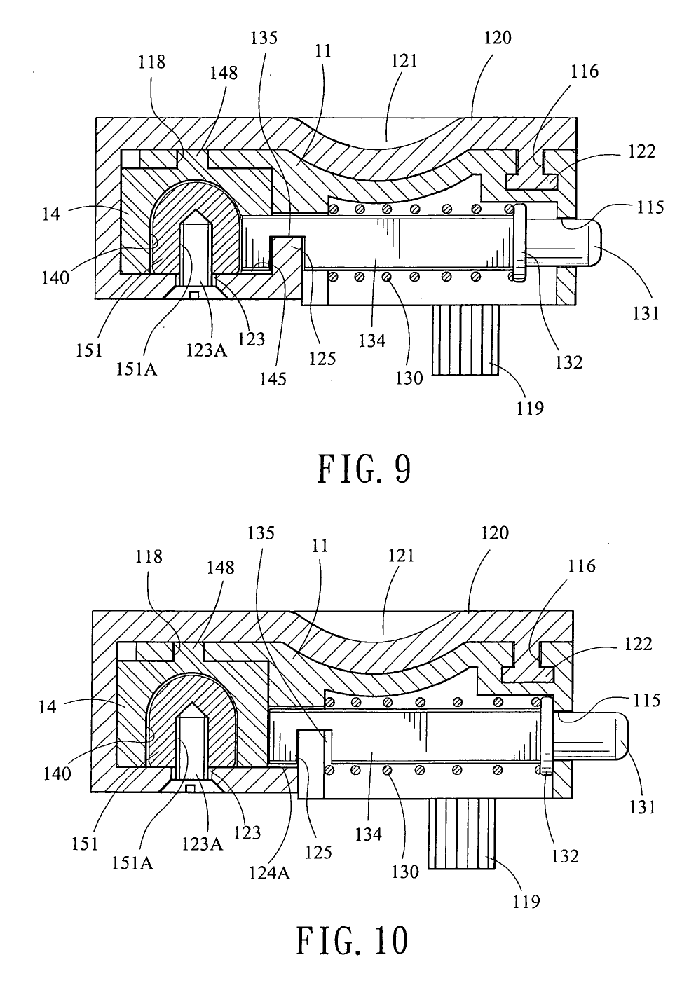

Referring to FIGS. 2 to 9 in conjunction with FIG. 1, the hasp 10 comprises a base 11 having two outer threaded members 119 on a bottom, the outer threaded members 119 being driven into a top of luggage case L for fastening, a sliding board 12, a trigger member 13, a spring seat 14, and a spring assembly 15. The base 11 further comprises a rectangular flat 113 having two spaced protuberances 113A formed thereon, three raised portions 110, 111, and 112 at three sides of the flat 113, a lengthwise inverted T-shaped groove 116 on the raised portion 112, a transverse channel 115 having a reduced opening under the groove 116, a lug 117 having a through hole 117A projected from an outer surface of the raised portion 112, a hole 118 on a top of the raised portion 111, and an inner threaded post 114 on a bottom of the raised portion 111.

The sliding board 12 comprises a rectangular top 120, an elongate bottom plate 124, a space 126 defined by the top 120 and the bottom plate 124, an indentation 121 on the top 120 to facilitate gripping by the finger, a pair of lugs 127 each having a through hole projected from an outer surface of one inclined side of the sliding board 12, a gap 128 between the lugs 127, a lengthwise inverted T-shaped rail 122 on a bottom of the top 120, a second rail 125 along one side of the bottom plate 124, the second rail 125 being parallel to the rail 122, a dent 124A on the second rail 125, and a threaded hole 123 on a bottom of the bottom plate 124.

The elongate spring seat 14 comprises a lengthwise receptacle 140 on a bottom, a projecting rod 141 at one end of the receptacle 140, a projection 148 on a top, a recess 144 at one end of the top, a threaded hole 143 on a bottom of the recess 144 open to the bottom of the spring seat 14, a well 145 adjacent the recess 144 and open to one side of the spring seat 14, and a screw 142 driven through the threaded hole 143 into the inner threaded post 114 for securing the spring seat 14 to the base 11 with the projection 148 inserted into the hole 118 for alignment purpose.

The spring assembly 15 comprises a helical spring 150 having one end put on the rod 141 for anchoring, and a moveable support 151 provided at the other end of the receptacle 140 and including a projecting rod 141 with the other end of the spring 150 put thereon for anchoring, a flat bottom 151A, and a vertical threaded aperture 153 on the bottom 151A. The elongate trigger member 13 comprises an outer push button 131, an annular flange 132 adjacent the push button 131, a bar 134 having a section of rectangle, a cavity 135 on a bottom of the bar 134 proximate an inner end, and a spring 130 put on the bar 134.

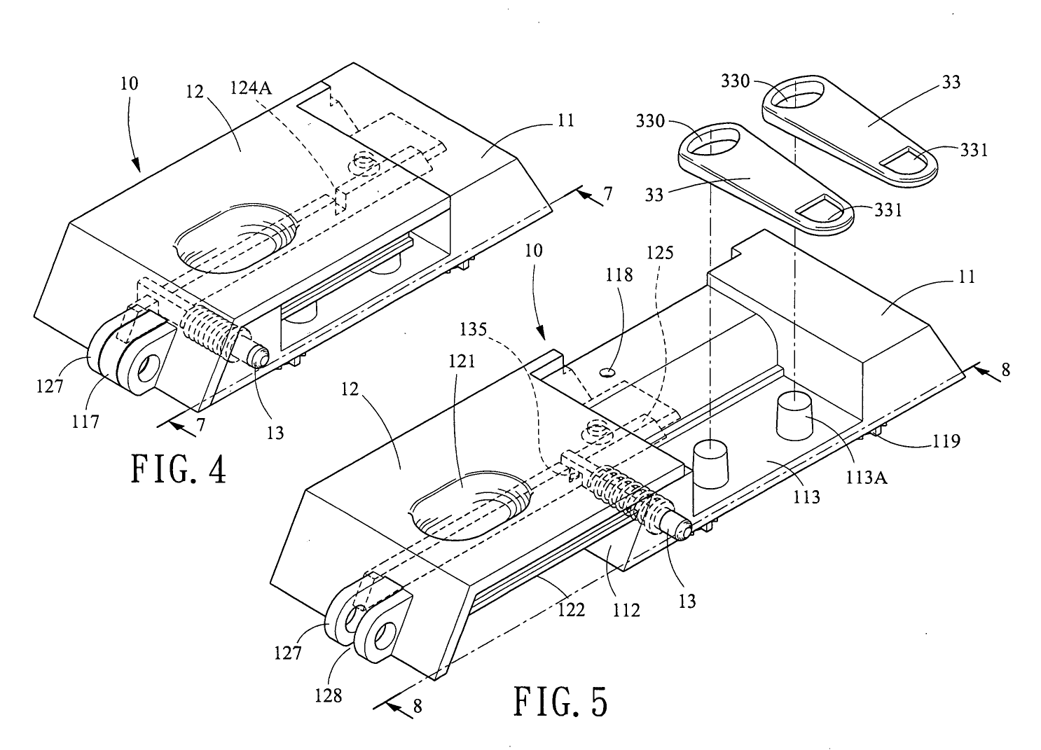

In a subsequent assembly of the invention, the trigger member 13 is inserted into the channel 115 with the flange 132 being disposed in the channel 115 in which the push button 131 is pressed continuously. Next, slide the sliding board 12 from one side of the base 11 with the rail 122 guided through the groove 116 and the second rail 125 slid through the cavity 135, and the inner end of the trigger member 13 disposed in the well 145 until the lug 117 is sandwiched between the lugs 127 (i.e., in the gap 128) with the holes of the lugs 117 and 127 aligned. Finally, drive a screw 123A through the threaded hole 123 into the aperture 153 for securing the bottom plate 124 to the spring assembly 15 (i.e., the spring assembly 15 and the sliding board 12 are fastened together). This finishes the assembly. At this position, the sliding board 12 is disposed on the base 11 and the protuberances 113A are located inside the sliding board 12 (i.e., inaccessible) as shown in FIG. 4.

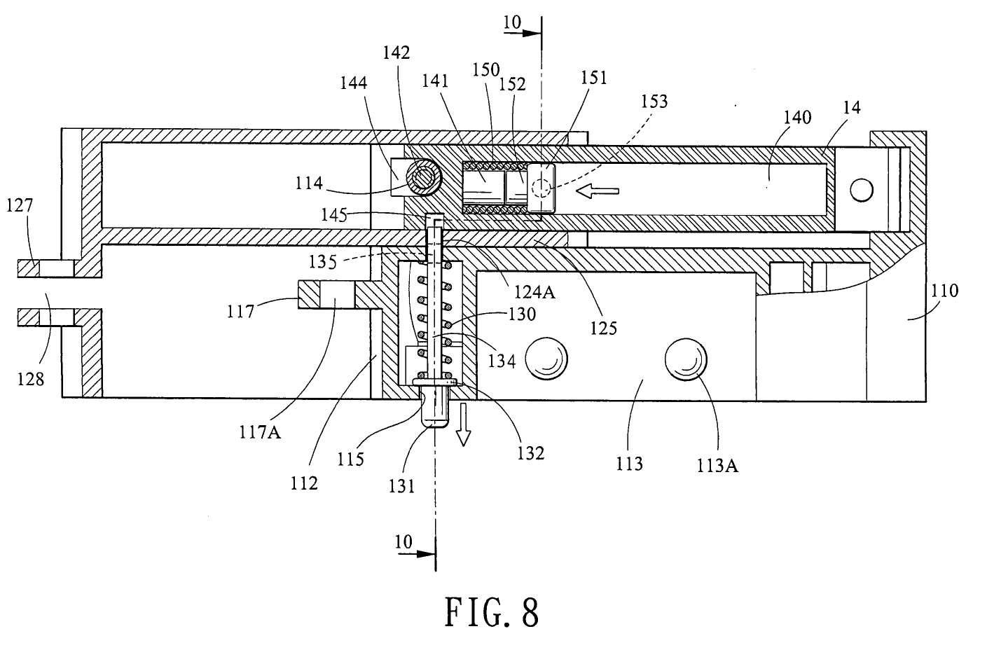

A fastening operation of the invention will now be described in detail below. Slide the sliding board 12 to compress the spring 150 by the support 151 by gripping the indentation 121. The protuberances 113A are exposed gradually in which the second rail 125 slides along the cavity 135 until a further sliding of the sliding board 12 is prohibited as shown in FIGS. 8 and 10. At this position, the spring 150 is compressed to its maximum and the protuberances 113A are fully exposed. Immediately after the dent 124A has slid to a position below the cavity 135, the trigger member 13 is pushed outwardly to urge the flange 132 against the reduced opening (i.e., shoulder) of the channel 115 and move the inner end of the trigger member 13 laterally in the dent 124A to block the sliding of the sliding board 12 as a result of the expansion of the spring 130. That is, the sliding board 12 is locked. Next, we can put one ends of the tabs 33 on the protuberances 113A. Thereafter, we can press the push button 131 inwardly to unlock the sliding board 12. Next, slide the sliding board 12 in a direction to fully dispose the sliding board 12 on the base 11 again (see FIGS. 2 and 5). Next, insert a shackle of the padlock 1OA through the holes of the lugs 127 and 117 into a shackle receiving hole thereof for fastening the hasp 10. To the contrary, for opening the luggage case a user can performs the steps of unfastening the padlock 10A, sliding the sliding board 12 to expose the protuberances 113A, disengaging the tabs 33 from the protuberances 113A, and pulling the tabs 33 away from each other.

While the invention herein disclosed has been described by means of specific embodiments, numerous modifications and variations could be made thereto by those skilled in the art without departing from the scope and spirit of the invention set forth in the claims.

What is claimed is:

1. A hasp mounted on a piece of luggage having two zippers which are operative to open or close the piece of luggage, comprising:
a base including a four-sided flat having two spaced protuberances formed thereon, first, second, and third raised portions at three sides of the flat, a lengthwise groove on the first raised portion, a transverse channel having a reduced opening under the groove, and a hole-shaped first positioning member projected from a side portion of the first raised portion;
a sliding board including a four-sided top, an elongate bottom plate under the top by a predetermined distance, a hole-shaped second positioning member projected from a first side portion of the top, a lengthwise first rail disposed on a bottom of the top, a second rail disposed along one side of the bottom plate, the second rail parallel to the first rail, and a dent on the second rail;
a spring seat secured to the base and including a lengthwise receptacle on a bottom, a projecting rod at one end of the receptacle, and a well disposed adjacent one end thereof;
a spring assembly including a spring having one end fixed at the rod, and a moveable support fixed at another end of the spring and secured to the sliding board; and
a trigger member including a flange adjacent an outer end, a spring depressible bar, and a cavity on a bottom of the bar proximate an inner end,
wherein in a closed state of each of the hasp and the piece of luggage, one ends of tabs of the zippers are put on the protuberances, the trigger member is seated across the channel with an outer end thereof projected from the channel, the bar disposed in the channel, the flange spaced apart from a shoulder of the channel, the cavity ridden on the second rail, and an inner end thereof disposed in the well, the sliding board is disposed on the first and the second raised portions and above the flat with the first positioning member aligned with the second positioning member so that a padlock is operative to fasten the first and the second positioning members, whereby unlocking the first and the second positioning members and sliding the sliding board away from the third raised portion will slide the first rail along the groove, slide the second rail along the cavity, and compress the spring until the dent has reached a position below the cavity to push the trigger member outwardly to urge the flange against the shoulder of the channel and move the inner end of the trigger member in the dent with the protuberances being exposed due to an expansion of the spring depressible bar.

2. The hasp of claim 1, wherein the spring seat further comprises a top projection and the second raised portion further comprises a hole with the projection fitted therein.

3. The hasp of claim 1, wherein the sliding board further comprises a top indentation.

4. The hasp of claim 1, wherein the groove has an inverted T-shaped section and the first rail has an inverted T-shaped section.

5. The hasp of claim 1, wherein the first positioning member is a lug and the second positioning member comprises two parallel lugs.

6. The hasp of claim 1, wherein the first positioning member comprises two parallel lugs and the second positioning member is a lug.
